(19) United States
(12) Patent Application Publication
(10) Pub. No.: US 2010/0244294 A1
(43) Pub. Date: Sep. 30, 2010

(54) SMC CROWN SHELLS

(75) Inventors: Naimul Karim, Maplewood, MN (US); Sumita B. Mitra, West St. Paul, MN (US); Marcelino Salviejo-Rivas, Eagan, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/741,849

(22) PCT Filed: Nov. 24, 2008
(86) PCT No.: PCT/US08/84524

§ 371 Date: May 7, 2010

Related U.S. Application Data
(60) Provisional application No. 60/990,672, filed on Nov. 28, 2007.

(51) Int. Cl. A61C 13/09; A61C 9/00; A61C 13/087

(52) U.S. Cl. 264/18; 249/54

(57) ABSTRACT

A dental article such as a crown is fabricating by layering one or more preformed shells of SMC material onto an understructure. The understructure may be fabricated from any suitably strong material for use in replacing dentition. At the same time, a number of SMC shells may be used to provide a finished dental article having a natural-looking, multi-chromatic appearance. The SMC material(s) may be cured to provide an exterior hardness suitable for use in dental applications.

### CROSS-REFERENCE TO RELATED APPLICATIONS

This application claims the benefit of U.S. Provisional Patent Application No. 60/990,672, filed Nov. 28, 2007.

### BACKGROUND

1. Field of the Invention

The invention relates to dentistry, and more particularly to fabricating dental articles using preformed shells of SMC material.

2. Description of the Related Art

A number of techniques are known for fabricating high-strength structures suitable for replacing human dentition. However, these techniques generally employ monolithic, high-strength materials capable of replacing the function of human dentition. While it is possible to physically paint or otherwise coat such structures, there remains a need for fabrication techniques that provide highly-aesthetic, multi-chromatic dental articles without requiring manual detailing of article surfaces.

### SUMMARY

A dental article such as a crown is fabricating by layering one or more preformed shells of SMC material onto an understructure. The understructure may be fabricated from any suitably strong material for use in replacing dentition. At the same time, a number of SMC shells may be used to provide a finished dental article having a natural-looking, multi-chromatic appearance. The SMC material(s) may be cured to provide an exterior hardness suitable for use in dental applications.

In one aspect, a method disclosed herein includes providing a plurality of shells having a range of colors and opacities, each one of the plurality of shells fashioned from a self-supporting, malleable, curable (SMC) material; fabricating an understructure for a dental article, the understructure having an exterior surface approximately matching an interior surface of each one of the plurality of shells; selecting one of the plurality of shells to provide a selected shell; placing the selected shell on the understructure; manually adjusting the selected shell to obtain a substantially exact fit to the exterior surface of the understructure; and curing the selected shell.

The understructure may include a majority of the volume of the dental article. The method may include reshaping the selected shell to obtain a desired exterior surface for the dental article. Reshaping may include placing the dental article in an articulating model and adjusting an occlusal fit of the dental article. Reshaping may include placing the dental article on a prepared tooth surface in human dentition and adjusting an occlusal fit of the dental article. The method may include curing the selected shell after reshaping the selected shell. The understructure may be a coping and the dental article may be a crown. The dental article may be a bridge. Fabricating the understructure may include fabricating the understructure using one or more digital three-dimensional models of the dental article. The method may include providing a second plurality of shells shaped to fit over one of the plurality of shells, the second plurality of shells having a range of colors and opacities, each one of the second plurality of shells fashioned from an SMC material. The method may include selecting one of the second plurality of shells to provide a second selected shell and placing the second selected shell onto the selected shell. The method may include partially curing the selected shell before placing the second selected shell onto the selected shell. The method may include selecting one of the plurality of shells and one of the second plurality of shells to obtain a multi-chromatic dental article. The method may include treating a surface of the selected shell to improve a bond with the second selected shell. The method may include automatically selecting one of the plurality of shells based upon a three-dimensional digital model of the dental article. The SMC material may include a resin system, a filler system, and an initiator system. The SMC material may include: a resin system comprising at least one ethylenically unsaturated component and a crystalline component; greater than 60 wt-% of a filler system; and an initiator system; wherein the SMC material exhibits sufficient malleability at a temperature of about 15° C. to 38° C. The SMC material may include a polymerizable compound and an organogelator. The organogelator may be a polymerizable organogelator.

In another aspect, a method disclosed herein includes providing a plurality of shells having a range of sizes including at least one shell having an exterior size and shape that fits within and abuts an inner surface of at least one other shell, each one of the plurality of shells fashioned from a self-supporting, malleable, curable (SMC) material; fabricating an understructure for a dental article, the understructure having an exterior surface approximately matching an interior surface of at least one of the plurality of shells; selecting a first one of the plurality of shells having an interior surface approximately matching the exterior surface of the understructure to provide a first selected shell; placing the first selected shell on the understructure; manually adjusting the first selected shell to obtain a substantially exact fit to the exterior surface of the understructure; and curing the first selected shell.

The understructure may include a majority of the volume of the dental article. The method may include selecting a second one of the plurality of shells having an interior surface approximately matching an exterior surface of the first one of the plurality of shells to provide a second selected shell. The method may include placing the second selected shell on the first selected shell and manually adjusting the second selected shell to obtain a substantially exact fit to the exterior surface of the first selected shell. The method may include curing the first selected shell before manually adjusting the second selected shell. The method may include curing the first selected shell before placing the second selected shell on the first selected shell. The method may include curing the second selected shell after manually adjusting the second selected shell.

In another aspect, a kit disclosed herein include a plurality of shells for building a dental article upon an understructure having a predetermined shape, each one of the plurality of shells fashioned from a self-supporting, malleable, curable (SMC) material, and the plurality of shells selected to provide at least two variations of a physical property.

The physical property may be a size, the kit including a plurality of shells having at least two different sizes. The plurality of shells may be shaped and sized so that at least one of the plurality of shells has an exterior surface substantially matching an interior surface of at least one other one of the plurality of shells. The physical property may be at least one of a color and an opacity. The at least two variations of the color and the opacity may be selected to permit construction of a multi-chromatic dental article. The physical property may include a shape, the kit including shells having two or more shapes for at least two different teeth. The SMC material may include a resin system, a filler system, and an initiator system. The SMC material may include: a resin system comprising at least one ethylenically unsaturated component and a crystalline component; greater than 60 wt-% of a filler system; and an initiator system; wherein the SMC material exhibits sufficient malleability at a temperature of about 15° C. to 38° C. The SMC material may include a polymerizable compound and an organogelator. The organogelator may be a polymerizable organogelator.

### BRIEF DESCRIPTION OF THE FIGURES

The invention and the following detailed description of certain embodiments thereof may be understood by reference to the following figures.

FIG. 1 shows a three-dimensional scanning system.

FIG. 2 shows a dental mill blank.

FIG. 3 shows a milling system.

FIG. 4 shows a preformed SMC shell.

FIG. 5 shows a dental article formed with a number of preformed shells.

FIG. 6 shows a method for fabricating a dental article.

### DETAILED DESCRIPTION

Described herein are systems and methods for fabricating a dental article using preformed SMC shells. While the description emphasizes certain specific steps and certain types of dental articles, it will be understood that additional variations, adaptations, and combinations of the methods and systems below will be apparent to one of ordinary skill in the art. For example there are a number of rapid fabrication technologies suitable for fabricating an understructure for use herein. Similarly, various types of cured or partially-cured materials may provide properties similar to SMC materials and might be employed to create preformed shells. Further, a number of three-dimensional scanning technologies are available that might be suitably adapted to obtaining three-dimensional scans for the uses described herein. In addition, while not specifically described below, it will be understood that a coping or other substructure or interim article of dental manufacture may be fabricated using the techniques described herein. All such variations, adaptations, and combinations are intended to fall within the scope of this disclosure.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives.

Unless explicitly indicated or otherwise clear from the context, the following conventions are employed in the following disclosure, and are intended to describe the full scope of the inventive concepts herein. All numbers expressing feature sizes, amounts, and physical properties used in the specification and claims are to be understood as being modified by the term “about.” Any numerical parameters set forth in this specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise. In a list, the term “or” means one or all of the listed elements or a combination of any two or more of the listed elements.

When a group is present more than once in a formula described herein, each group is “independently” selected, whether specifically stated or not. For example, when more than one M group is present in a formula, each M group is independently selected.

The terms “three-dimensional surface representation”, “digital surface representation”, “three-dimensional surface map”, and the like, as used herein, are intended to refer to any three-dimensional surface map of an object, such as a point cloud of surface data, a set of two-dimensional polygons, or any other data representing all or some of the surface of an object, as might be obtained through the capture and/or processing of three-dimensional scan data, unless a different meaning is explicitly provided or otherwise clear from the context. A “three-dimensional representation” may include any of the three-dimensional surface representations described above, as well as volumetric and other representations, unless a different meaning is explicitly provided or otherwise clear from the context.

Terms such as “digital dental model”, “digital dental impression” and the like, are intended to refer to three-dimensional representations of dental objects that may be used in various aspects of acquisition, analysis, prescription, and manufacture, unless a different meaning is otherwise provided or clear from the context. Terms such as “dental model” or “dental impression” are intended to refer to a physical model, such as a cast, printed, or otherwise fabricated physical instance of a dental object. Unless specified, the term “model”, when used alone, may refer to either or both of a physical model and a digital model.

As used herein, the term “room temperature” refers to a temperature of 20° C. to 25° C. or 22° C. to 25° C.

The term “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “dental object”, as used herein, is intended to refer broadly to subject matter specific to dentistry. This may include intraoral structures such as dentition, and more typically human dentition, such as individual teeth, quadrants, full arches, pairs of arches which may be separate or in occlusion of various types, soft tissue, and the like, as well as bones and any other supporting or surrounding structures. As used herein, the term “intraoral structures” refers to both natural structures within a mouth as described above and artificial structures such as any of the dental objects described below that might be present in the mouth. As used herein, the term dental article is intended to refer to a man-made dental object. Dental articles may include “restorations”, which may be generally understood to include components that restore the structure or function of existing dentition, such as crowns, bridges, veneers, inlays, onlays, amalgams, composites, and various substructures such as copings and the like, as well as temporary restorations for use while a permanent restoration is being fabricated. Dental articles may also include a “prosthesis” that replaces dentition with removable or permanent structures, such as dentures, partial dentures, implants, retained dentures, and the like. Dental articles may also include “appliances” used to correct, align, or otherwise temporarily or permanently adjust dentition, such as removable orthodontic appliances, surgical stents, bruxism appliances, snore guards, indirect bracket placement appliances, and the like. Dental articles may also include “hardware” affixed to dentition for an extended period, such as implant fixtures, implant abutments, orthodontic brackets, and other orthodontic components. Dental articles may also include “interim components” of dental manufacture such as dental models (full or partial), wax-ups, investment molds, and the like, as well as trays, bases, dies, and other components employed in the fabrication of restorations, prostheses, and the like. Dental objects may also be categorized as natural dental objects such as the teeth, bone, and other intraoral structures described above or as artificial dental objects (i.e., dental articles) such as the restorations, prostheses, appliances, hardware, and interim components of dental manufacture as described above. A dental article may be fabricated intraorally, extraorally, or some combination of these.

The following description emphasizes the use of self-supporting, malleable, curable (SMC) materials, also referred to herein as “hardenable compositions.” In general, an SMC material is self-supporting in the sense that the material has sufficient internal strength before curing to be formed into a desired shape that can be maintained for a period of time, such as to allow for transportation and storage. An SMC material is malleable in the sense that it is capable of being custom shaped and fitted under moderate force, such as a force that ranges from light finger pressure to that applied with manual operation of a small hand tool, such as a dental composite instrument. An SMC material is curable in the sense that it can be cured using light, heat, pressure or the like. For dental applications, the material may be both partially curable to improve rigidity during certain handling steps, and fully curable to a hardness suitable for use as a dental article. The forgoing characteristics are now discussed in greater detail.

The term “self-supporting” as used herein means that an article is dimensionally stable and will maintain its preformed shape without significant deformation at room temperature (i.e., about 20° C. to about 25° C.) for at least two weeks when free-standing (i.e., without the support of packaging or a container). In many embodiments, the uncured shells described herein are dimensionally stable at room temperature for at least one month, or for at least six months. In some embodiments, the shells are dimensionally stable at temperatures above room temperature, or up to 40° C., or up to 50° C., or up to 60° C. This definition applies in the absence of conditions that activate any initiator system and in the absence of an external force other than gravity.

The terms “malleable” or having “sufficient malleability” as used herein in reference to SMC materials indicates that the material is capable of being custom-shaped and fitted onto an understructure, or shaped into a suitable shell, under a moderate manual force (i.e., a force that ranges from light finger pressure to that applied with manual operation of a small hand tool, such as a dental composite instrument). The shaping, fitting, forming, etc., can be performed by adjusting the external shape and internal cavity shape of the SMC shell before or after layering the shell onto an understructure or another shell. In many embodiments, the SMC materials may exhibit the desired sufficient malleability at temperatures of, e.g., 40 degrees Celsius or less. In other instances, the SMC materials may exhibit “sufficient malleability” in a temperature range of, e.g., 15° C. to 38° C.

The terms “curable” or “hardenable” are used interchangeably herein to refer to materials that can be cured to lose their sufficient malleability. The hardenable (i.e., curable) materials may be irreversibly hardenable, which, as used herein, means that after hardening such that the composition loses its malleability it cannot be converted back into a malleable form without destroying the external shape of the resulting product. Examples of some potentially suitable hardenable compositions that may be used to construct the SMC shells described herein with sufficient malleability may include, e.g., hardenable organic compositions (filled or unfilled), polymerizable dental waxes, hardenable dental compositions having a wax-like or clay-like consistency in the unhardened state, etc. In some embodiments, the shells are constructed of hardenable compositions that consist essentially of non-metallic materials.

Numerous SMC materials are described, for example in the following references, each of which is incorporated herein by reference: U.S. patent application Ser. No. 10/921,648 to Karim et al. entitled Hardenable Dental Article and Method of Manufacturing the Same, filed on Aug. 19, 2004 and published on May 12, 2005 as U.S. Pub. No. 2005/0100868; U.S. patent application Ser. No. 10/749,306 to Karim et al. entitled Curable Dental Mill Blanks and Related Methods, filed on Dec. 31, 2003 and published on Jul. 7, 2005 as U.S. Pub. No. 2005/0147944; U.S. patent application Ser. No. 10/643,771 to Kvitrud et al. entitled Dental Crown Forms and Methods, filed on Aug. 19, 2003 and published on Feb. 24, 2005 as U.S. Pub. No. 2005/0042577; U.S. patent application Ser. No. 10/643,748 to Oxman et al. entitled Dental Article Forms and Methods, filed on Aug. 19, 2003 and published on Feb. 24, 2005 as U.S. Pub. No. 2005/0042576; U.S. patent application Ser. No. 10/219,398 to Karim et al. entitled Hardenable Self-Supporting Structures and Methods, filed on Aug. 15, 2002 and published on Jun. 19, 2003 as U.S. Pub. No. 2003/0114553; and International Patent Application No. US06/016197 to Karim et al. entitled Malleable Symmetric Dental Crowns. In addition, 3M™, of St. Paul, Minn., markets a shell temporization made of SMC material under the trade name PROTEMP™ Crown. More generally, any material having self-supporting, malleable, curable characteristics suitable for use in the shells described herein may be suitably employed.

A number of potentially suitable SMC materials are now described in greater detail.

With respect to the hardenable compositions described in certain of the above applications, the unique combination of highly malleable properties (preferably without heating above room temperature or body temperature) before hardening (e.g., cure) and high strength (preferably, e.g., a flexural strength of at least about 25 MPa) after hardening may provide preformed shells with numerous potential advantages. For example, a preformed shell that is sufficiently malleable can facilitate forming of a desired shape, such as by fitting an interior surface of a shell to a substructure or forming an exterior surface of a shell to fit with surrounding dentition. Because the compositions are hardenable, the adjusted external shape can also be retained permanently as desired. As described above, useful hardenable compositions for the SMC materials described herein may include e.g., polymerizable waxes, hardenable organic materials (filled or unfilled), etc. Some potentially suitable hardenable compositions may include those described in U.S. Pat. No. 5,403,188 to Oxman et al.; U.S. Pat. No. 6,057,383 to Volkel et al.; and U.S. Pat. No. 6,799,969 to Sun et al.

The SMC materials described above may include a resin system that includes a crystalline component, greater than 60 percent by weight (wt-%) of a filler system (preferably, greater than 70 wt-% of a filler system), and an initiator system, wherein the hardenable composition exhibits sufficient malleability to be formed onto a prepared tooth, preferably at a temperature of about 15° C. to 38° C. (more preferably, about 20° C. to 38° C., which encompasses typical room temperatures and body temperatures). In some embodiments, the hardenable compositions do not need to be heated above body temperature (or even about room temperature) to become malleable as discussed herein.

At least a portion of the filler system of a hardenable composition may include particulate filler. In this and various other embodiments, if the filler system includes fibers, the fibers may be present in an amount of less than 20 wt-%, based on the total weight of the composition.

The crystalline component may provide a morphology that assists in maintaining the self-supporting first shape. This morphology includes a noncovalent structure, which may be a three-dimensional network (continuous or discontinuous) structure. If desired, the crystalline component can include one or more reactive groups to provide sites for polymerizing or crosslinking. If such crystalline components are not present or do not include reactive groups, or optionally where crystalline components are present and do include reactive groups, such reactive sites may be provided by another resin component, such as an ethylenically unsaturated component.

Thus, for certain embodiments, the resin system includes at least one ethylenically unsaturated component. Ethylenically unsaturated components can be selected from the group consisting of mono-, di-, or poly-acrylates and methacrylates, unsaturated amides, vinyl compounds (including vinyl oxy compounds), and combinations thereof. This ethylenically unsaturated component can be the crystalline component or noncrystalline.

The crystalline component can include polyesters, polyethers, polyolefins, polythioethers, polyarylalkylenes, polysilanes, polyamides, polyurethanes, or combinations thereof. The crystalline component can include saturated, linear, aliphatic polyester polyols containing primary hydroxyl end groups. The crystalline component can optionally have a dendritic, hyperbranched, or star-shaped structure, for example.

The crystalline component can optionally be a polymeric material (i.e., a material having two or more repeat units, thereby including oligomeric materials) having crystallizable pendant moieties and the following general formula:

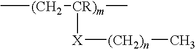

wherein R is hydrogen or a (C₁-C₄) alkyl group, X is —CH₂—, —C(O)O—, —O—C(O)—, —C(O)—NH—, —HN—C(O)—, —O—, —NH—, —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions.

Alternative to, or in combination with, the crystalline component, the hardenable composition can include a filler that is capable of providing a morphology to the composition that includes a noncovalent structure, which may be a three-dimensional network (continuous or discontinuous) structure, that assists in the maintenance of the first shape. In some embodiments, such a filler has nanoscopic particles, or the filler is an inorganic material having nanoscopic particles. To enhance the formation of the noncovalent structure, the inorganic material can include surface hydroxyl groups. In some embodiments, the inorganic material includes fumed silica.

In some embodiments, the composition includes, in addition to a resin system and an initiator system, either a crystalline component or a filler system that includes a particulate filler (e.g, a micron-size particulate filler, a nanoscopic particulate filler, a colloidal or fumed filler, a prepolymerized organic filler, or any combination of these), or both a crystalline component and a filler system. Furthermore, the use of one or more surfactants may also enhance the formation of such a noncovalent structure, and a surfactant system may optionally be employed. As used herein, a filler system includes one or more fillers and a surfactant system includes one or more surfactants.

Another potential embodiment may include a hardenable composition that includes a resin system, a filler system at least a portion of which is an inorganic material having nanoscopic particles with an average primary particle size of no greater than about 50 nanometers (nm), a surfactant system, and an initiator system. The hardenable composition can exhibit sufficient malleability to be formed onto a prepared tooth at a temperature of about 15° C. to 38° C. In embodiments with a surfactant system and nanoscopic particles, the resin system can include at least one ethylenically unsaturated component, and the filler system is present in an amount of greater than 50 wt-%.

In other embodiments, hardenable compositions may include a resin system that includes: a noncrystalline component selected from the group consisting of mono-, di-, or poly-acrylates and methacrylates, unsaturated amides, vinyl compounds, and combinations thereof; and a crystalline component selected from the group consisting of polyesters, polyethers, polyolefins, polythioethers, polyarylalkylenes, polysilanes, polyamides, polyurethanes, polymeric materials (including oligomeric materials) having crystallizable pendant moieties and the following general formula:

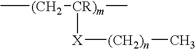

wherein R is hydrogen or a (C₁-C₄) alkyl group, X is —CH₂—, —C(O)O—, —O—C(O)—, —C(O)—NH—, —HN—C(O)—, —O—, —NH—, or —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions, and combinations thereof. The hardenable composition may further include greater than about 60 wt-% of a filler system and an initiator system. The hardenable composition can exhibit sufficient malleability to be formed onto a prepared tooth at a temperature of about 15° C. to 38° C. If the filler system includes fibers, the fibers may be present in an amount of less than 20 wt-%, based on the total weight of the hardenable composition.

In yet another embodiment, the hardenable compositions includes a resin system with a crystalline compound of the formula:

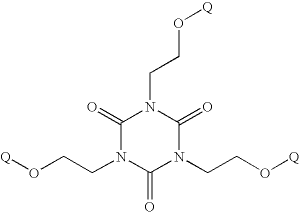

wherein each Q independently comprises polyester segments, polyamide segments, polyurethane segments, polyether segments, or combinations thereof; a filler system; and an initiator system.

The SMC material may include organogelators and polymerizable components that can be used in a variety of dental applications.

In one embodiment, the SMC material includes a polymerizable component, an organogelator, and a crystalline material. In another embodiment, the SMC material includes a hardenable dental composition that includes a polymerizable component, an organogelator, and 60% or more filler material. In another embodiment, the SMC material includes a hardenable dental composition that includes a polymerizable component, an organogelator, and filler material comprising nanoscopic particles. In another embodiment, the SMC material includes a hardenable dental composition that includes a polymerizable component and a polymerizable organogelator.

In certain embodiments, the hardenable composition can be in the form of a hardenable, self-supporting (i.e., free-standing) structure having a first shape. The self-supporting structure has sufficient malleability to be reformed into a second shape, thereby providing for simplified customization of a device, e.g., simplified customized fitting of a dental prosthetic device. Once reformed into a second shape, the composition can be hardened using, for example, a free radical curing mechanism under standard photopolymerization conditions to form a hardened composition with improved mechanical properties. Significantly, for certain embodiments of the compositions described herein, the hardened structure does not need an additional veneering material.

In certain embodiments, the hardenable composition includes an organogelator of the general formula (Formula I):

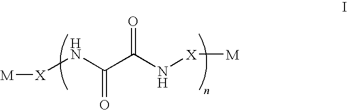

wherein each M is independently hydrogen or a polymerizable group; each X is independently an alkylene group, cycloalkylene group, arylene group, arenylene group, or a combination thereof, and n is 1 to 3. Such organogelators are also provided by the present invention.

Herein, an “organogelator” is a generally low molecular weight organic compound (generally no greater than 3000 g/mol) that forms a three-dimensional network structure when dissolved in an organic fluid, thereby immobilizing the organic fluid and forming a non-flowable gel that exhibits a thermally reversible transition between the liquid state and the gel state when the temperature is varied above or below the gel point of the mixture.

Herein, the “polymerizable component” can include one or more resins, each of which can include one or more monomers, oligomers, or polymerizable polymers.

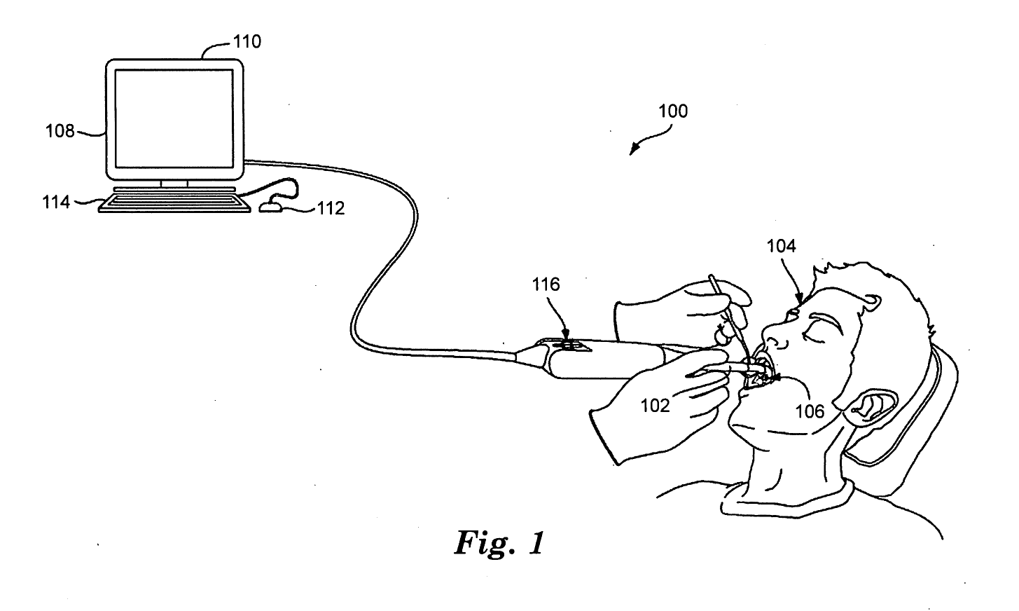

FIG. 1 shows a three-dimensional scanning system that may be used with the systems and methods described herein. In general, the system 100 may include a scanner 102 that captures images from a surface 106 of a subject 104, such as a dental patient, and forwards the images to a computer 108, which may include a display 110 and one or more user input devices such as a mouse 112 or a keyboard 114. The scanner 102 may also include an input or output device 116 such as a control input (e.g., button, touchpad, thumbwheel, etc.) or a display (e.g., LCD or LED display) to provide status information.

The scanner 102 may include any camera or camera system suitable for capturing images from which a three-dimensional point cloud may be recovered. For example, the scanner 102 may employ a multi-aperture system as disclosed, for example, in U.S. patent application Ser. No. 11/530,420 to Rohály et al. entitled Three-Channel Camera Systems with Collinear Apertures, filed on Sep. 8, 2006 and published on Aug. 16, 2007 as U.S. Pub. No. 2007/0188769, the entire content of which is incorporated herein by reference. While Rohaly discloses certain multi-aperture systems, it will be appreciated that any multi-aperture system suitable for reconstructing a three-dimensional point cloud from a number of two-dimensional images may similarly be employed. In one multi-aperture embodiment, the scanner 102 may include a plurality of apertures including a center aperture positioned along a center optical axis of a lens, along with any associated imaging hardware. The scanner 102 may also, or instead, include a stereoscopic, triscopic or other multi-camera or other configuration in which a number of cameras or optical paths are maintained in fixed relation to one another to obtain two-dimensional images of an object from a number of slightly different perspectives. The scanner 102 may include suitable processing for deriving a three-dimensional point cloud from an image set or a number of image sets, or each two-dimensional image set may be transmitted to an external processor such as contained in the computer 108 described below. In other embodiments, the scanner 102 may employ structured light, laser scanning, direct ranging, or any other technology suitable for acquiring three-dimensional data, or two-dimensional data that can be resolved into three-dimensional data.

In one embodiment, the scanner 102 is a handheld, freely positionable probe having at least one user input device 116, such as a button, lever, dial, thumb wheel, switch, or the like, for user control of the image capture system 100 such as starting and stopping scans. In an embodiment, the scanner 102 may be shaped and sized for dental scanning. More particularly, the scanner may be shaped and sized for intraoral scanning and data capture, such as by insertion into a mouth of an imaging subject and passing over an intraoral surface 106 at a suitable distance to acquire surface data from teeth, gums, and so forth. The scanner 102 may, through such a continuous acquisition process, capture a point cloud of surface data having sufficient spatial resolution and accuracy to prepare dental objects such as prosthetics, hardware, appliances, and the like therefrom, either directly or through a variety of intermediate processing steps. In other embodiments, surface data may be acquired from a dental model such as a dental prosthetic, to ensure proper fitting using a previous scan of corresponding dentition, such as a tooth surface prepared for the prosthetic.

Although not shown in FIG. 1, it will be appreciated that a number of supplemental lighting systems may be usefully employed during image capture. For example, environmental illumination may be enhanced with one or more spotlights illuminating the subject 104 to speed image acquisition and improve depth of field (or spatial resolution depth). The scanner 102 may also, or instead, include a strobe, flash, or other light source to supplement illumination of the subject 104 during image acquisition.

The subject 104 may be any object, collection of objects, portion of an object, or other subject matter. More particularly with respect to the dental fabrication techniques discussed herein, the object 104 may include human dentition captured intraorally from a dental patient's mouth. A scan may capture a three-dimensional representation of some or all of the dentition according to a particular purpose of the scan. Thus the scan may capture a digital model of a tooth, a quadrant of teeth, or a full collection of teeth including two opposing arches, as well as soft tissue or any other relevant intraoral structures. In other embodiments where, for example, a completed fabrication is being virtually test fit to a surface preparation, the scan may include a dental prosthesis such as an inlay, a crown, or any other dental prosthesis, dental hardware, dental appliance, or the like. The subject 104 may also, or instead, include a dental model, such as a plaster cast, wax-up, impression, or negative impression of a tooth, teeth, soft tissue, or some combination of these.

The computer 108 may be, for example, a personal computer or other processing device. In one embodiment, the computer 108 includes a personal computer with a dual 2.8 GHz Opteron central processing unit, 2 gigabytes of random access memory, a TYAN Thunder K8WE motherboard, and a 250 gigabyte, 10,000 rpm hard drive. This system may be operated to capture approximately 1,500 points per image set in real time using the techniques described herein, and store an aggregated point cloud of over one million points. As used herein, the term “real time” means generally with no observable latency between processing and display. In a video-based scanning system, real time more specifically refers to processing within the time between frames of video data, which may vary according to specific video technologies between about fifteen frames per second and about thirty frames per second. More generally, processing capabilities of the computer 108 may vary according to the size of the subject 104, the speed of image acquisition, and the desired spatial resolution of three-dimensional points. The computer 108 may also include peripheral devices such as a keyboard 114, display 110, and mouse 112 for user interaction with the camera system 100. The display 110 may be a touch screen display capable of receiving user input through direct, physical interaction with the display 110.

Communications between the computer 108 and the scanner 102 may use any suitable communications link including, for example, a wired connection or a wireless connection based upon, for example, IEEE 802.11 (also known as wireless Ethernet), BlueTooth, or any other suitable wireless standard using, e.g., a radio frequency, infrared, or other wireless communication medium. In medical imaging or other sensitive applications, wireless image transmission from the scanner 102 to the computer 108 may be secured. The computer 108 may generate control signals to the scanner 102 which, in addition to image acquisition commands, may include conventional camera controls such as focus or zoom.

In an example of general operation of a three-dimensional image capture system 100, the scanner 102 may acquire two-dimensional image sets at a video rate while the scanner 102 is passed over a surface of the subject. The two-dimensional image sets may be forwarded to the computer 108 for derivation of three-dimensional point clouds. The three-dimensional data for each newly acquired two-dimensional image set may be derived and fitted or “stitched” to existing three-dimensional data using a number of different techniques. Such a system employs camera motion estimation to avoid the need for independent tracking of the position of the scanner 102. One useful example of such a technique is described in commonly-owned U.S. patent application Ser. No. 11/270,135 to Zhang et al. entitled Determining Camera Motion, filed on Nov. 8, 2005 and published on May 10, 2007 as U.S. Pub. No. 2007/0103460, the entire content of which is incorporated herein by reference. However, it will be appreciated that this example is not limiting, and that the principles described herein may be applied to a wide range of three-dimensional image capture systems.

The display 110 may include any display suitable for video or other rate rendering at a level of detail corresponding to the acquired data. Suitable displays include cathode ray tube displays, liquid crystal displays, light emitting diode displays and the like. In some embodiments, the display may include a touch screen interface using, for example capacitive, resistive, or surface acoustic wave (also referred to as dispersive signal) touch screen technologies, or any other suitable technology for sensing physical interaction with the display 110.

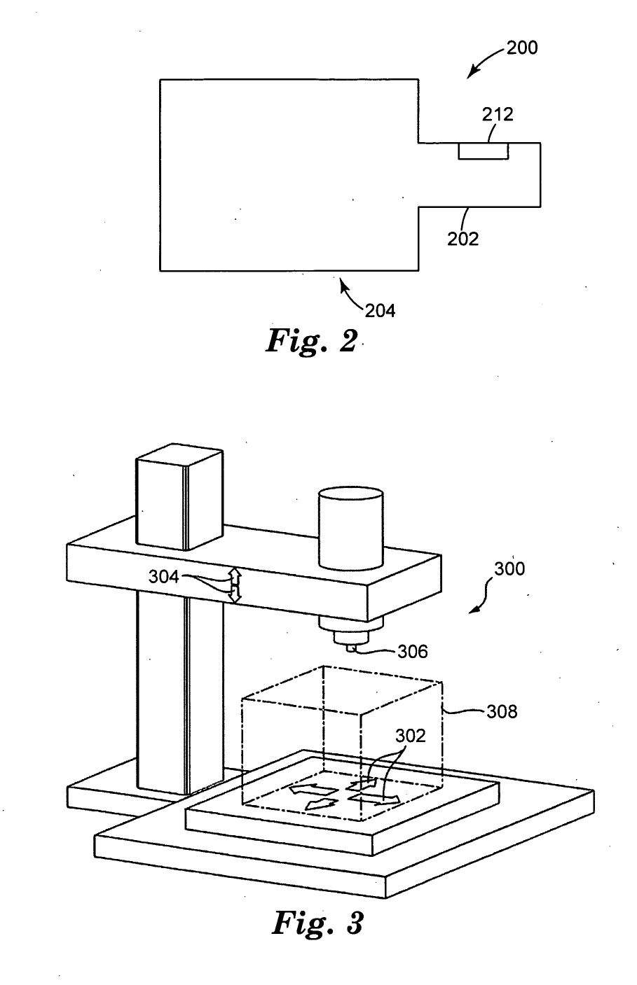

FIG. 2 shows a dental mill blank that may be used with the systems and methods described herein in a side view. In general, a dental mill blank 200 includes a stem 202 and a body 204 formed of a millable material. The dental mill blank 200 may also optionally include an identifier 212 such as a bar code or Radio-Frequency Identification (RFID) tag. It will be appreciated that notwithstanding the description of milling processes herein, other techniques may be suitably employed to fabricate an understructure for SMC shells including, for example, a variety of rapid fabrication techniques as well as known techniques for fabricating a conventional coping or the like.

The stem 202 may optionally be provided to support the blank 200 during milling or other handling, and may be shaped to fit into a corresponding chuck or other support of a milling machine or similar hardware for shaping the blank 200 through the selective removal of material therefrom. For a mill blank 200 formed from a single material, the mill blank may generally have a body 204 of adequate volume to mill a desired dental article therefrom. It will be understood that the blank 200 may be selected or fabricated to match a predetermined tooth size, as determined for example by direct measurement of a site for which a restoration or the like is to be fabricated.

The body 204 may be formed of any suitable material for milling dental articles, which may include materials that can be milled directly into a final article and materials that can be cured or otherwise processed into a final hardness after milling. A number of millable materials suitable for use in dental applications are known in the art including for example ceramics, a porcelains, ceramic silica, micaceous ceramics, polymeric resins, or combinations of these, as well as in certain embodiments one or more of the SMC materials described above. The material of the mill blank may also be selected to impart desired optical properties into a dental article constructed using SMC shells as described herein. Thus for example the body 204 may be selected to have a translucence, color, or shade matching that of dentin, or may be selected to provide an appearance in the resulting restoration of the desired optical property or properties. The material of the body 204 may also or instead be selected to achieve on or more mechanical (i.e., structural) properties of dentin in a cured dental article milled from the blank 200. Thus for example the material may be selected to support a tooth structure in ordinary use, or more generally to provide a desired degree of resistance to fracture, hardness, pliability or the like to a core region of a restoration. In particular, these characteristics may be selected to match the corresponding mechanical properties of a natural tooth structure in a dental article fabricated from the blank 200 and one or more SMC shells as described herein.

The mill blank 200 may optionally include an identifier 212. The identifier 212 may be a bar code, RFID tag, or other identifier that uniquely identifies the blank 200 or associates the blank 200 with one or more properties. The identifier 212 may, for example, be a bar code, serial number, or other human-readable or machine-readable indicia on an exterior surface of the blank 200. The identifier 212 may also be affixed to packaging for the blank 200. The identifier 212 may also, or instead, include an RFID tag or the like physically embedded within the blank 200. In these latter embodiments, the RFID tag may be positioned in a portion of the blank, such as the outer layer 210, that is intended to be removed by milling, or the RFID tag may be positioned within the body 204 so that a restoration or other dental article fabricated from the blank 200 carries the information within the RFID tag. In one embodiment, the identifier 212 may encode a unique identification number for the blank 200. This number may be used to obtain any information cross-referenced to that unique number, which may include data concerning materials, size, shape, and color of the mill blank 200, or dental articles intended to be milled therefrom, and any other data useful to a dentist preparing a dental article from the mill blank 200, or useful to a machine such as a computer-controlled milling machine that operates on the mill blank 200. In another aspect, the identifier 212 may directly encode data concerning the blank such as a batch number, a shape, a shelf life, and so forth. More generally, any information useful for handling or using the blank 200 may be encoded directly within the identifier 212, or obtained using a unique identifier encoded within the identifier 212. It will be appreciated that the identifier 212 may also, or instead, encode non-unique information that is in turn used to obtain relevant data for the blank 200. All such variations to and combinations of the foregoing are intended to fall within the scope of this disclosure.

FIG. 3 shows a milling system that may be used with the systems and methods herein. In particular, FIG. 3 illustrates a Computerized Numerically Controlled (“CNC”) milling machine 300 including a table 302, an arm 304, and a cutting tool 306 that cooperate to mill under computer control within a working envelope 308. In operation, a workpiece (not shown) may be attached to the table 302. The table 302 may move within a horizontal plane and the arm 304 may move on a vertical axis to collectively provide x-axis, y-axis, and z-axis positioning of the cutting tool 306 relative to a workpiece within the working envelope 308. The cutting tool 306 may thus be maneuvered to cut a computer-specified shape from the workpiece.

Milling is generally a subtractive technology in that material is subtracted from a block rather than added. Thus pre-cut workpieces approximating commonly milled shapes may advantageously be employed to reduce the amount of material that must be removed during a milling job, which may reduce material costs and/or save time in a milling process. More specifically in a dental context, it may be advantageous to begin a milling process with a precut piece, such as a generic coping, rather than a square block. A number of sizes and shapes (e.g., molar, incisor, etc.) of preformed workpieces may be provided so that an optimal piece may be selected to begin any milling job. Various milling systems have different degrees of freedom, referred to as axes. Typically, the more axes available (such as 4-axis milling), the more accurate the resulting parts. High-speed milling systems are commercially available, and can provide high throughputs.

In addition a milling system may use a variety of cutting tools, and the milling system may include an automated tool changing capability to cut a single part with a variety of cutting tools. In milling a dental model, accuracy may be adjusted for different parts of the model. For example, the tops of teeth, or occlusal surfaces, may be cut more quickly and roughly with a ball mill and the prepared tooth and dental margin may be milled with a tool resulting in greater detail and accuracy.

All such milling systems as may be adapted for use with the dental mill blanks 200 described herein are intended to fall within the scope of the term “milling” as used herein, and a milling process may employ any such milling systems. More generally, as used herein “milling” may refer to any subtractive process including abrading, polishing, controlled vaporization, electronic discharge milling (EDM), cutting by water jet or laser or any other method of cutting, removing, shaping or carving material, unless a different meaning is explicitly provided or otherwise clear from the context. Inputs to the milling system may be provided from three-dimensional scans of dentition using, e.g., the scanner 102 of FIG. 1, three-dimensional scans of working models (which may also be created from a three-dimensional scan), CAD/CAM models (which may also be derived from a three-dimensional scan), or any other suitable source. It should be further understood that, while milling is one example of a digitally-subtractive technique, and a computer-controlled milling machine is a readily commercially available digitally-subtractive device, that other techniques for removing material under computer control are also known, and may be suitably adapted to use as a digitally-subtractive method or system as disclosed herein. This includes, for example, cutting, skiving, sharpening, lathing, abrading, sanding, and the like. Such uses are intended to fall within the scope of this disclosure.

It will be understood that while milling systems represent one commercially available system for fabricating understructures for the dental articles, a variety of other fabrication techniques exist and may be adapted to the uses described herein. Such systems include, for example, stereolithography systems, three-dimensional printing systems, and digital light processing systems. In addition, conventional casting techniques based upon physical impressions and manual shaping may be employed to fabricate an understructure for use in the methods described herein. All such variations are intended to fall within the scope of this disclosure.

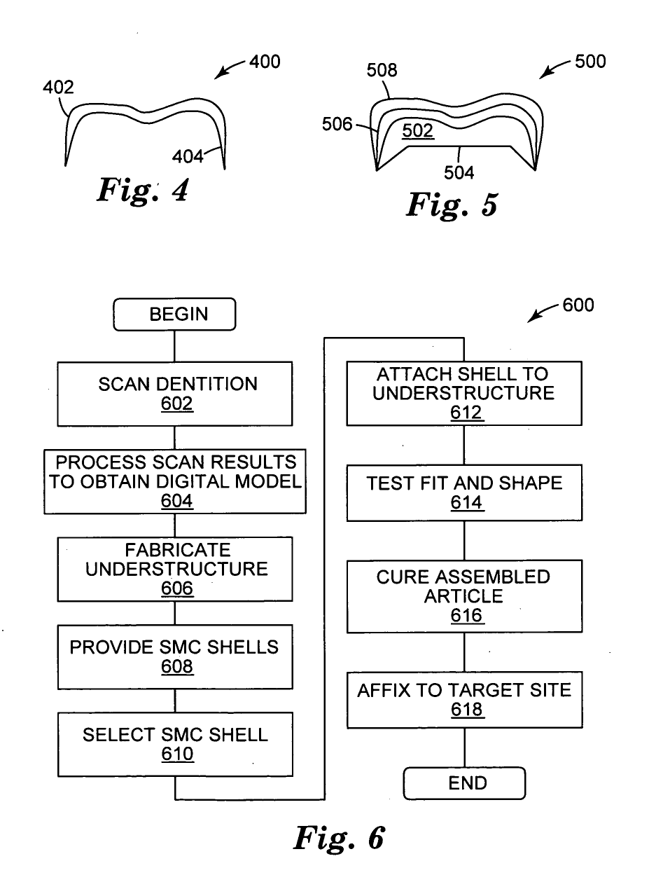

FIG. 4 shows a preformed SMC shell. In general, the shell 400 includes in inner surface 404 and an outer surface 402.

The outer surface 402 may have a shape intended to match a natural tooth structure being replaced in a dental procedure. In one aspect, SMC shells for the outer surface 402 may be provided in a variety of natural enamel shades. Where the outer surface 402 is intended to serve as an outer surface of a dental article that replaces tooth structure, the outer surface 402 may have a number of functional properties suitable to function in place of the replaced tooth structure and/or cooperate with surrounding dentition. Where an article is too resistant to wear, it may cause undue abrasion to surrounding natural tooth surfaces. Other properties of the outer surface of natural dentition that may usefully be replaced by the outer surface 402 include chip resistance, polish retention, and hardness. Where a multi-layer article is being fabricated, the outer surface 402 may have a shape intended to match an inner surface of an additional SMC shell.

The inner surface 404 may be shaped to fit onto an understructure (not shown), which may have a surface fabricated to substantially mate with the contours of the inner surface 404. This may be a precise matching, e.g., within any reasonable tolerances of measurement and fabrication of the understructure, or this may be a loose matching, such that the uncured or partially cured SMC shell 400 can be tightly fitted to the understructure through application of manual pressure or the like.

The SMC material may be any of the SMC materials described above, and may have various optical properties as generally described below. Depending upon the method used, the SMC material may be in various stages of curing, for example according to whether the shell 400 will be subjected to further shaping.

It will be noted that the depicted shell 400 is shaped approximately in a form for creation of a crown. However, the actual shape will depend upon the type and size of dental article being fabricated, and the corresponding tooth where the dental article is to be used.

It will also be noted that the depicted shell 400 includes a taper along the bottom edge thereof. While a preformed SMC shell 400 may be fabricated with a taper, it is also possible to manually apply the taper after the shell 400 is layered onto an understructure (or another shell, not shown). In another aspect, the shell 400 may have no taper, with the understructure sized to form a final dental article that includes the full thickness of the shell 400 along a bottom edge thereof. All such variations to the shell 400 as would be apparent to one of ordinary skill in the art are intended to fall within the scope of this disclosure.

FIG. 5 shows a dental article formed with a number of preformed shells. The article 500 may include understructure 502 having a bottom surface 504 shaped to attached to a prepared tooth surface, a first SMC shell 506, and a second SMC shell 508. In general, the understructure 502 will form a majority of the total volume of the dental article 500 and will be fabricated from a material providing adequate structural integrity to support the dental article 500 in normal use. However, in embodiments this understructure 502 may form less than a majority of the final volume of the dental article 500. In one aspect, the understructure 502 may be a coping for a crown, although more generally the understructure and shells 506, 508 may be adapted to any number of dental articles, and the shape of a coping for use with the techniques described herein may vary from a conventional coping shape. The techniques for fabricating the article, and variations thereto, are described below with reference to FIG. 6. As described in certain examples, an SMC shell may be cured, partially cured, or uncured. Further, partial curing may include partially curing all or a portion of the SMC shell, all according to the manner in which the shells are used to fabricate a dental article. It will be understood that while FIG. 5 depicts a crown, a variety of dental articles may be fabricated using understructures and shells and described herein, including any of the dental articles described above. It should be noted in general that, while a two-shell article is depicted, any number of shells may be employed.

Shells may be provided with various colors, shades, opacities, sheens, and other visual or optical properties so that a number of shells can be selected and layered to provide a multi-chromatic dental article. In one aspect, a multi-chromatic article is achieved using differences in visual properties between the understructure 502 and a single SMC shell layer. In another aspect, more complex multi-chromatic articles are achieved using the visual properties of a number of SMC shell layers.

Shells may also or instead be provided that impart desired mechanical or functional properties to a dental article. For example shells may be fashion of materials that can be cured to have properties such as wear resistance, chip resistance, polish retention, strength, and the like corresponding to natural dentition. This may include, for example, an exterior layer having wear resistance selected to match natural dentition, thus mitigating unnatural wear on opposing teeth when a dental article is in use. By contrast, interior shells may be fabricated from materials curable to have high strength or fracture resistance, thus strengthening or supporting the mechanical role of the understructure.

In addition, a kit may be provided that contains a plurality of shells packaged together in a box, case, or other packaging. Each shell may be fashioned of an SMC material, and the kit may contain shells having a variety of physical properties. This includes, for example any of the visual or optical properties described above. This may also include size, which may vary according to the size of a tooth that will receive the dental article. The size may also vary according to a layer for which the shell is intended. In other words, shells for a first layer may have a first, relatively smaller size, while shells for a second layer may have a second size that can fit over a shell from the first layer, and so forth. Similarly, the shape may vary according to layer. For example, a first layer may have an inner surface shaped to correspond to the general shape of a prepared tooth surface or to the specific shape of a specific prepared tooth surface. Similarly an outer layer may have an outer surface that corresponds to a desired exterior shape of a dental article. One or more intermediate layers may also be employed to fill a volume between an innermost layer and an outermost layer. Shape may also include a number of different shapes for different types of teeth, or for different types of dental articles. A kit as described herein may include any two or more of the shells described above when packaged together or otherwise connected. For multi-layer articles, a kit may include a group of shells for each layer. It will be understood that particular groups of shells may be more usefully combined for certain fabrication processes, and all such combinations are intended to fall within the scope of this disclosure.

FIG. 6 shows a method for fabricating a dental article using preformed SMC shells.

The process 600 may begin by scanning dentition as shown in step 602. This may include an acquisition of a three-dimensional surface representation or other digital model of a patient's dentition using, e.g., the scanning system described above with reference to FIG. 1. Where a tooth surface is prepared to receive a restoration or the like, step 602 may include a scan before preparation to capture the original, natural shape of the tooth structure being replaced. Step 602 may also, or instead, include a scan of the prepared tooth surface, which may be used in subsequent steps to fabricate a mating, bonding surface of a dental article. Step 602 may also, or instead, include a scan of surrounding dentition including, for example, an opposing arch, neighboring teeth, soft tissue, and the like, any of which might be usefully employed in computer-assisted design of a dental article for the prepared tooth surface.

As shown in step 604, the scan results from step 602 may be processed to obtain a digital model for a computer-controlled milling machine or other rapid fabrication system. This may include a wide array of modeling steps. For example, a preliminary or final digital model may be obtained through superposition of pre- and post-preparation scans of a tooth surface, thus permitting the direct fabrication of a replacement article that corresponds physically to the removed structure. A number of dental CAD tools also exist that may be used to create models for restorations and the like from preliminary scan-based models, or from generic tooth models and the like in a dental CAD model library or the like. In addition, some combination of these techniques may be employed.

Once a digital model has been obtained, an understructure may be fabricated as shown in step 606. The fabrication may be performed using rapid fabrication techniques such as stereolithography, digital light processing, three-dimensional printing, and computerized milling. Fabrication may, where appropriate, include curing of the understructure or partial curing of the understructure. For example, a deformable mill blank of SMC material may be employed. The mill blank may be shaped into a form suitable for milling a particular dental article, and then partially cured to hold its deformed shape during milling. This may also, or instead, include partial spatial curing, such as curing the stem or other support structures for the mill blank. It will be appreciated that such interim curing steps are optional, and will depend on the particular fabrication procedures and materials being used, as well as the particular dental article being fabricated. It will be appreciated that, while a digitally fabricated understructure as described above may be usefully employed with the SMC shells described herein, other understructures such as a conventional coping may also or instead be employed.

As shown in step 608, a plurality of SMC shells may be provided. This may include, for example, one of the kits described above, or more generally any combination of shells suitable for a particular fabrication process.

As shown in step 610, one of the plurality of SMC shells may be selected for addition to the understructure. Data from the scan of step 602 or the digital modeling of step 604 may be used to select a suitable shell, or to assist in human selection of a suitable shell. For example, where data from the scan includes video or still images, this visual information may be employed to identify visual characteristics of a dental article. This data may, in turn be applied to select a suitable arrangement of one or more shells to match the visual characteristics. As another example, where the scan or digital model include spatial information for both the understructure and a completed dental article, a series of shell layers may be identified to build the resulting dental article on the understructure.

As shown in step 612, the shell selected in step 610 may be attached to the understructure, using, for example, adhesives or a partial cure. The shell may be pressed on to the understructure, or otherwise deformed to form a substantially exact fit with an exterior surface of the understructure on order to obtain good bonding between layers and structural integrity to the assembled article. In one aspect, a tool may be provide to apply uniform pressure to the outside surfaces of the shell while concurrently forming an outside surface of the shell, such as to conform to the interior shape of a subsequent shell or to match a desired exterior tooth shape.

As shown in step 614, the resulting dental article may be test fit and the SMC material(s) may be shaped as desired. This may be performed directly on a prepared tooth surface in a patient's dentition, or using a dental model, an articulator, or the like. So for example, the dental article may be placed into an articulating model, and manual adjustments may be made to static or dynamic occlusal fit. Any number of test fits may be performed, after which manual adjustments or re-milling may be performed to adjust occlusal fit, proximal contacts, and the like or otherwise reshape the dental article to obtain a desired exterior shape.

It will be appreciated that steps 610-614 may be repeated as desired to create a multi-layer exterior of SMC materials on an understructure. During these repeated steps, the materials may be reshaped, cured, partially cured, or otherwise treated. For example, each outer layer may be abraded to assist in bonding with subsequent layers, or coated with a curable adhesive prior to addition of another shell, or cured to hold its shape during the addition of further shells. As a significant advantage, the SMC materials described herein may be manually adjusted with relative ease. So for example, an outer shape of a final restoration or the like can be manipulated by a technician or dentist prior to curing, and the resulting shape can be cured to a final hardness for use in human dentition.

As shown in step 616, once an adequate fit has been achieved the article may optionally be cured to final hardness where additional curing is required for the milling material or any layers added to the surface thereof. Additional reshaping and fitting may be performed after curing to final hardness.

As shown in step 618, the final dental article may be permanently affixed to a target site in a patient's dentition such as by adhering the article using any number of suitable dental adhesives including without limitation self-adhesive cements. Additional reshaping and fitting may be performed after affixing to the target site, for example in response to patient or dentist observations concerning occlusal fit and the like. The article may also be finished, polished, or otherwise processed for final use (which may also occur before the article is permanently affixed to a site.

It will be understood that the above process 600 is merely exemplary. Any number of adaptations may be made, and steps may be added or removed from the process 600 as described. For example, where SMC materials are employed in the understructure, the entire dental article may be retained in an at least partially uncured state until the article is permanently affixed to a target site. This technique usefully permits a degree of deformation of the dental article to more closely mate with a prepared tooth surface or surrounding dentition, and permits a degree of reshaping to the article after it is affixed to a site. In another aspect also suitable for use with SMC materials, the entire article except for the portion mating to a prepared tooth surface may be fully cured, with malleability preserved at the mating surface to achieve a closer final fit. All such variations as would be clear to one of ordinary skill in the art are intended to fall within the scope of this disclosure.

In one aspect, the process 600 may be configured for chairside dental use. Thus a dentist may fabricate a coping using, e.g., scan data and an in-office dental milling system. The dentist may then select shells to impart a desired shape and appearance to a final dental article. In another aspect, the process 600 may be configured for use with a dental laboratory, in which case digital scan data would be transmitted to a dental laboratory which may use automated or manual processes to select and assemble SMC shells onto a digitally fabricated understructure.

It will be appreciated that various aspects of the methods described above and the scanner, milling system, and other components may be embodied in hardware, software, or any combination of these suitable for the data acquisition and fabrication technologies described herein. This includes realization in one or more microprocessors, microcontrollers, embedded microcontrollers, programmable digital signal processors or other programmable devices, along with internal and/or external memory. The realization may also, or instead, include one or more application specific integrated circuits, programmable gate arrays, programmable array logic components, or any other device or devices that may be configured to process electronic signals. It will further be appreciated that a realization may include computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the scanning device, milling machine, and so forth in a number of ways or all of the functionality may be integrated into a dedicated, standalone device. All such permutations and combinations are intended to fall within the scope of the present disclosure.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood with reference to the following claims, which are to be interpreted in the broadest sense allowable by law.

1. A method comprising:
providing a plurality of shells having a range of colors and opacities, each one of the plurality of shells fashioned from a self-supporting, malleable, curable (SMC) material;
fabricating an understructure for a dental article, the understructure having an exterior surface approximately matching an interior surface of each one of the plurality of shells;
selecting one of the plurality of shells to provide a selected shell;
placing the selected shell on the understructure;
manually adjusting the selected shell to obtain a substantially exact fit to the exterior surface of the understructure; and
curing the selected shell.

2. The method of claim 1 wherein the understructure includes a majority of the volume of the dental article.

3. The method of claim 1 further comprising reshaping the selected shell to obtain a desired exterior surface for the dental article.

4. The method of claim 3 wherein reshaping includes placing the dental article in an articulating model and adjusting an occlusal fit of the dental article.

5. The method of claim 3 wherein reshaping includes placing the dental article on a prepared tooth surface in human dentition and adjusting an occlusal fit of the dental article.

6. The method of claim 3 further comprising curing the selected shell after reshaping the selected shell.

7. The method of claim 1 wherein the understructure is a coping and the dental article is a crown.

8. The method of claim 1 wherein the dental article is a bridge.

9. The method of claim 1 wherein fabricating the understructure includes fabricating the understructure using one or more digital three-dimensional models of the dental article.

10. The method of claim 1 further comprising providing a second plurality of shells shaped to fit over one of the plurality of shells, the second plurality of shells having a range of colors and opacities, each one of the second plurality of shells fashioned from an SMC material.

11. The method of claim 10 further comprising selecting one of the second plurality of shells to provide a second selected shell and placing the second selected shell onto the selected shell.

12. The method of claim 11 further comprising partially curing the selected shell before placing the second selected shell onto the selected shell.

13. The method of claim 11 further comprising selecting one of the plurality of shells and one of the second plurality of shells to obtain a multi-chromatic dental article.

14. The method of claim 11 further comprising treating a surface of the selected shell to improve a bond with the second selected shell.

15. The method of claim 1 further comprising automatically selecting one of the plurality of shells based upon a three-dimensional digital model of the dental article.

16. The method of claim 1 wherein the SMC material includes a resin system, a filler system, and an initiator system.

17. The method of claim 16 wherein the SMC material includes:
a resin system comprising at least one ethylenically unsaturated component and a crystalline component;
greater than 60 wt-% of a filler system; and
an initiator system;
wherein the SMC material exhibits sufficient malleability at a temperature of about 15° C. to 38° C.

18. The method of claim 1 wherein the SMC material includes a polymerizable compound and an organogelator.

19. The method of claim 18 wherein the organogelator is a polymerizable organogelator.

20. A method comprising:
providing a plurality of shells having a range of sizes including at least one shell having an exterior size and shape that fits within and abuts an inner surface of at least one other shell, each one of the plurality of shells fashioned from a self-supporting, malleable, curable (SMC) material;
fabricating an understructure for a dental article, the understructure having an exterior surface approximately matching an interior surface of at least one of the plurality of shells;
selecting a first one of the plurality of shells having an interior surface approximately matching the exterior surface of the understructure to provide a first selected shell;
placing the first selected shell on the understructure;
manually adjusting the first selected shell to obtain a substantially exact fit to the exterior surface of the understructure; and
curing the first selected shell.

21. The method of claim 20 wherein the understructure includes a majority of the volume of the dental article.

22. The method of claim 20 further comprising selecting a second one of the plurality of shells having an interior surface approximately matching an exterior surface of the first one of the plurality of shells to provide a second selected shell.

23. The method of claim 22 further comprising placing the second selected shell on the first selected shell and manually adjusting the second selected shell to obtain a substantially exact fit to the exterior surface of the first selected shell.

24. The method of claim 23 further comprising curing the first selected shell before manually adjusting the second selected shell.

25. The method of claim 23 further comprising curing the first selected shell before placing the second selected shell on the first selected shell.

26. The method of claim 23 further comprising curing the second selected shell after manually adjusting the second selected shell.

27. A kit comprising a plurality of shells for building a dental article upon an understructure having a predetermined shape, each one of the plurality of shells fashioned from a self-supporting, malleable, curable (SMC) material, and the plurality of shells are shaped and sized so that at least one of the plurality of shells has an exterior surface substantially matching an interior surface of at least one other one of the plurality of shells.

28-32. (canceled)

33. The kit of claim 27 wherein the SMC material includes a resin system, a filler system, and an initiator system.

34. The kit of claim 33 wherein the SMC material includes:
a resin system comprising at least one ethylenically unsaturated component and a crystalline component;
greater than 60 wt-% of a filler system; and
an initiator system;
wherein the SMC material exhibits sufficient malleability at a temperature of about 15° C. to 38° C.

35. The kit of claim 27 wherein the SMC material includes a polymerizable compound and an organogelator.

36. The kit of claim 35 wherein the organogelator is a polymerizable organogelator.
